(19) United States
(12) Patent Application Publication
(10) Pub. No.: US 2009/0240810 A1
(43) Pub. Date: Sep. 24, 2009

(54) Method of Digital Resource Management and Related Digital Resource Management System

(76) Inventor: Chia-Jui Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/391,266

(22) Filed: Feb. 24, 2009

(30) Foreign Application Priority Data
Mar. 21, 2008 (TW) 097110225

(51) Int. Cl. G06F 15/173

(52) U.S. Cl. 709/226; 726/26

(57) ABSTRACT

A method of digital resource management includes establishing an OSGi framework between a user end and a service end, providing an application service via the OSGi framework for the user end by the service end according to a request of the user end, and exchanging information corresponding to the application service via the OSGi framework for managing the application service.

### Background of the Invention

1. Field of the Invention

The present invention relates to a method of digital resource management and related digital resource management system, and more particularly, to a method of service rights management based on an open service gateway initiative framework and related digital resource management system.

2. Description of the Prior Art

Digital resource management (DRM) refers to a technology for a publisher to authorize use of protected objects, targeting at digital contents such as software, music, movies, and so on. The commonly applied technology is Microsoft© Windows Media Digital Rights Management (WMDRM).

Through DRM, a user can use DRM devices to obtain license and encrypted digital-content files, and decrypt the files. Therefore, the prior art DRM stresses on protection for digital video but not on digital resources related to digital home services, such as management of value-added application services (e.g. home care, network security, etc.), causing limitation of the application range.

In addition to protection of digital contents, management of digital resources shall contain maintenance of related application services or software, such as check or update of media software. However, the prior art DRM does not contain maintenance of above-mentioned application services or software, causing insufficiency in application.

Moreover, the prior art DRM is usually applied for media players. Each media player needs to be installed a specific software for supporting DRM, causing limitation of the application range. Furthermore, the prior art DRM does not support to install, update, delete or perform system software. If the system software is changed, the user, service providers and manufacturers of media player devices may have difficulty in use and maintenance, causing complexity of system maintenance.

### SUMMARY OF THE INVENTION

It is therefore a primary objective of the claimed invention to provide a method of DRM and related DRM system.

The present invention discloses a method of DRM, which includes establishing an Open Service Gateway initiative, abbreviated OSGi hereinafter, framework between a user end and a service end, providing an application service via the OSGi framework for the user end by the service end according to a request of the user end, and exchanging information corresponding to the application service between the user end and the service end via the OSGi framework for managing the application service.

The present invention further discloses a system of DRM, which includes an OSGi framework, a user end, and a service end. The user end includes an OSGi management interface connected to the OSGi framework for receiving an application service and related control signals via the OSGi framework, a front-end registration and activation unit established on the OSGi management interface for registering and activating authority for using the application service, a front-end application service subscription unit established on the OSGi management interface for subscribing the application service, a service certification unit established on the OSGi management interface for certificating the application service, an front-end application service encryption and decryption unit established on the OSGi management interface for decrypting the application service, an application service monitoring unit established on the OSGi management interface for monitoring information of the application service, and an application service execution unit established on the OSGi management interface for performing the application service. The service end includes a back-end registration and activation unit for processing the registration of the user end and the activation of the application service, an application service publication and subscription unit for publishing the application service and processing the subscription of the application service, a user-end request verification unit for verifying the use end, an application service passport generation unit for managing status of the user end corresponding to the application service, a back-end application service encryption and decryption unit for decrypting the application service and a passport corresponding to the application service, an application service package unit for packaging the application service in an OSGi format, an application service server unit for exporting the application service to the user end via the OSGi framework, and a storage unit for storing data corresponding to the application service and the user end.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a process according to an embodiment of the present invention.

FIG. 2 is a schematic diagram of a DRM system according to an embodiment of the present invention.

FIG. 3 is a schematic diagram of the user end shown in FIG. 2 according to an embodiment of the present invention.

FIG. 4 is a schematic diagram of the service end shown in FIG. 2 according to an embodiment of the present invention.

FIG. 5 is a schematic diagram of a process of subscription, installation, and update of the application service in the DRM system shown in FIG. 2 according to an embodiment of the present invention.

FIG. 6 is a schematic diagram of a cancellation process of the application service in the DRM system shown in FIG. 2 according to an embodiment of the present invention.

FIG. 7 is a schematic diagram of a periodic certification process of the application service in the DRM system shown in FIG. 2 according to an embodiment of the present invention.

FIG. 8 is a schematic diagram of an execution and activation process of the application service in the DRM system shown in FIG. 2 according to an embodiment of the present invention.

### DETAILED DESCRIPTION

The present invention applies an Open Services Gateway Initiative (OSGi) technique for the Service Rights Management (SRM), i.e. the present invention discloses an OSGi-based SRM.

Firstly, illustrate OSGi. With the rapid development of Internet, Internet services are blooming, and no longer limited in job scope, but associated with home life instead, so that lifestyle of digital home is started. In digital home services, a home gateway, communicating with internal and external networks, plays a crucial role. All kinds of devices in a house can communicate with each other through the home gateway.

OSGi is an integrated platform of information services, integrated into a gateway, so that application programs and value-added services, provided by a remote service provider, can be dynamically downloaded to the home gateway via Internet, and automatically installed. The above-mentioned gateway can be a set-top box, ADSL modem, cable modem, residential gateway, and so on, connecting to home network, office network, and wide area network (WAN).

In OSGi standard, an Open Service Gateway (OSG) is the most important device for an OSGi network, which externally connects to the service provider via WAN ports, and internally connects to the home network via local area network (LAN) ports. The user can remote control home devices in the home network or adjust configuration thereof via OSG.

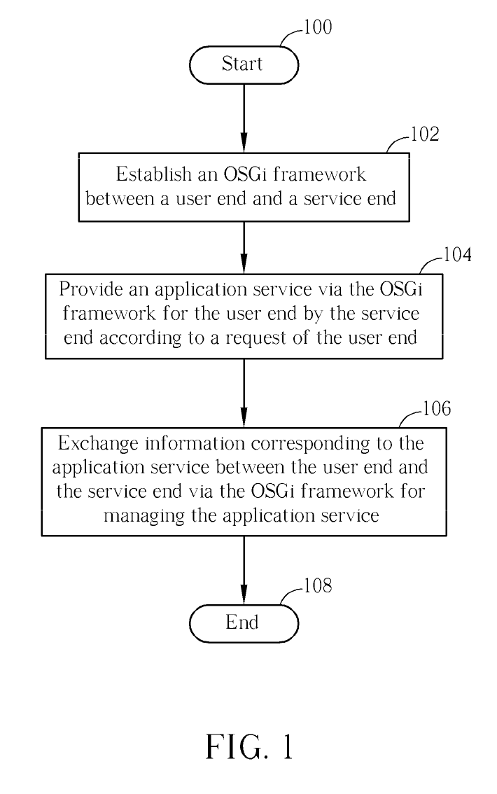

Therefore, via OSGi, the present invention can manage service rights more efficiently. Please refer to FIG. 1. FIG. 1 is a schematic diagram of a process 10 according to an embodiment of the present invention. The process 10 is utilized for managing digital resources, and comprises the following steps:

Step 100: Start.

Step 102: Establish an OSGi framework between a user end and a service end.

Step 104: Provide an application service via the OSGi framework for the user end by the service end according to a request of the user end.

Step 106: Exchange information corresponding to the application service between the user end and the service end via the OSGi framework for managing the application service.

Step 108: End.

Therefore, in the process 10, the present invention manages an application service via the OSGi framework. Under the OSGi framework, the user end is capable of registering and activating authority for using the application service, subscribing, certificating, en-/decrypting, monitoring, and performing the application service. Accordingly, the service end is capable of processing the registration of the user end and the activation of the application service, publishing the application service, processing the subscription of the application service, verifying the use end, encrypting the application service and a passport corresponding to the application service, packaging the application service in an OSGi format, exporting the application service to the user end via the OSGi framework, and storing data of the user end and corresponding to the application service.

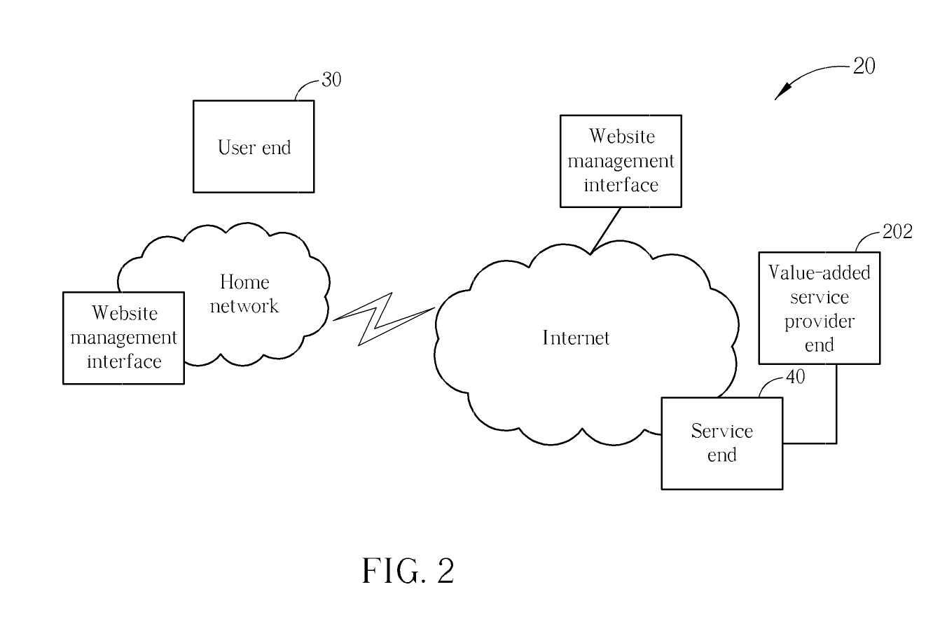

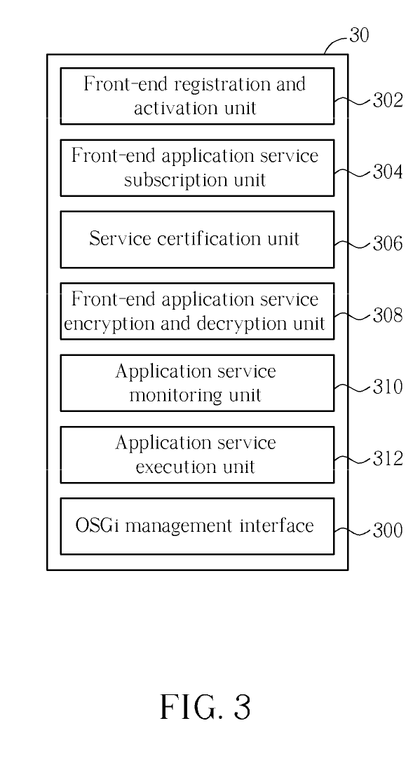

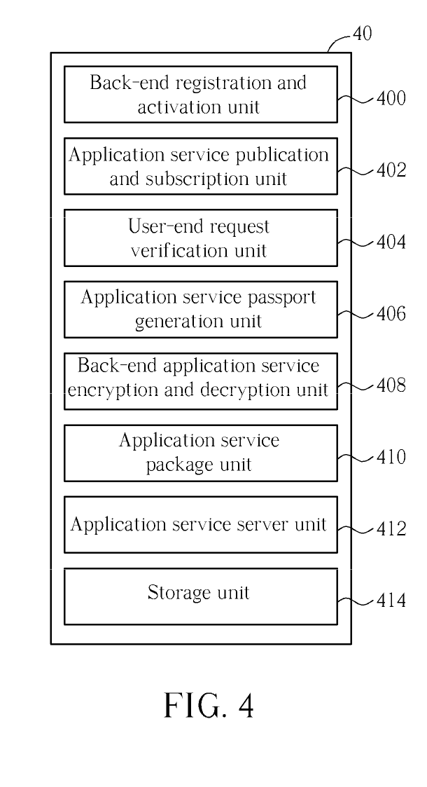

Further illustrate the process 10 as follows. Please refer to FIG. 2. FIG. 2 is a schematic diagram of a DRM system 20 according to an embodiment of the present invention. The DRM system 20 is established according to the OSGi framework, and includes a user end 30 and a service end 40. Under the OSGi framework, a user can use a website management interface to manage operations of the user end 30 via home network or Internet, in order to subscribe, certificate, en-/decrypt, monitor, and perform an application service provided by a value-added service provider end 202. Please further refer to FIG. 3 and FIG. 4. FIG. 3 is a schematic diagram of the user end 30 shown in FIG. 2. FIG. 4 is a schematic diagram of the service end 40 shown in FIG. 2. The user end 30 includes an OSGi management interface 300, a front-end registration and activation unit 302, a front-end application service subscription unit 304, a service certification unit 306, a front-end application service encryption and decryption unit 308, an application service monitoring unit 310, and an application service execution unit 312. The service end 40 includes a back-end registration and activation unit 400, an application service publication and subscription unit 402, a user-end request verification unit 404, an application service passport generation unit 406, a back-end application service encryption and decryption unit 408, an application service package unit 410, an application service server unit 412, and a storage unit 414.

In the user end 30, when the user end 30 first uses the OSGi framework, the DRM system 20 requests the user end 30 to register information and activate authority for using the application service. Then, the front-end registration and activation unit 302 exchanges the en-/decryption protocol and key with the back-end registration and activation unit 400, and transmits the encrypted user information and related framework identification data to the back-end registration and activation unit 400 via network. After the registration and activation processes are completed, the user end 30 begins to use and subscribe the application service. The front-end application service subscription unit 304 can automatically update and download lists provided by the value-added service provider end 202 for the user to select a new application service, or update or suspend the current application service. The service certification unit 306 is utilized for analyzing the downloaded information content of the application service, i.e. passport, in order to determine whether to store, perform or certificate the application service. Since each application service, software, or digital content is encrypted and transmitted after packaged with the corresponding passport, the front-end application service encryption and decryption unit 308 is utilized for encrypting and decrypting the downloaded application service after certification. The application service monitoring unit 310 is utilized for periodically checking passports of each application service, in order to determine whether the downloaded application service is legal and valid, and delete illegal and expired application services accordingly. Meanwhile, the application service monitoring unit 310 is capable of periodically checking if each application service needs to be updated. The application service execution unit 312 is utilized for requesting the service certification unit 306 to confirm whether the corresponding application service is legal and valid, performing the application service according to the operating method designated by the passport of the application service, requesting the front-end application service encryption and decryption unit 308 to en-/decrypt the application service, performing program required by the application service for using the application service, and updating data of the passport of the application service for operations of the application service monitoring unit 310. Furthermore, the OSGi management interface 300 supports remote control via network, to install, activate, update, stop, and delete the required application service manually, automatically, or in schedule.

On the other hand, in service end 40, the back-end registration and activation unit 400 is utilized for exchanging en-/decryption protocol and key with the front-end registration and activation unit 302, and receiving registration data, framework identification data, and requests of service activation exported by the front-end registration and activation unit 302. Meanwhile, the back-end registration and activation unit 400 is capable of recording and storing the registration data, framework identification data, en-/decryption protocol, en-/decryption key exported by the user end 30. The application service publication and subscription unit 402 is utilized for publishing service lists to the user end 30 for notifying the user of the latest information, as the value-added service provider end 202 provides new application service. Moreover, the application service publication and subscription unit 402 is capable of receiving subscription, cancellation, and update requests of the application service from the user end 30, notifying the front-end application service subscription unit 304 to download, install, or update the application service, and updating the user information of the user. The user-end request verification unit 404 is utilized for verifying whether the user end 30 is a legal user, in order to determine whether the request is to be processed. The application service passport generation unit 406 is capable of combining user information, application service information, and authority of use, to generate a passport corresponding to the user end 30 and a specific application service, and manage status of the user end 30 corresponding to the application service. The back-end application service en-/decryption unit 408 is utilized for encrypting and decrypting the application service and the corresponding passport requested by the user end 30 according to the en-/decryption protocol and key of the user end 30. The application service package unit 410 is utilized for packaging the encrypted or decrypted application service and passport thereof into a bundle, which is published to the user end 30 by the application service publication and subscription unit 402. The application service server unit 412 is utilized for replying the remote installation or update of the application service resource requested by the OSGi management interface 300, so that the OSGi management interface 300 is capable of downloading, installing, and updating the application service via network. The storage unit 414 is utilized for storing data required by the service end 40, such as user information, application service bundles and other data, and so on.

In the present invention, the passport of the application service is taken as SRM rules, preferably conforms to a format of Extensible Markup Language (XML) and is encrypted. Each application service corresponding to a user comprises an individual passport packaged together. In other words, the same application services corresponding to different users have different passports. Moreover, the present invention is able to modify or expand content or format of the passport according to different application situations, and most important, software to be modified can be remote installed, updated, performed, stopped, and deleted automatically and dynamically via the OSGi framework. Thus, cost and complexity of system maintenance can be reduced.

Note that, the passport of the application service is taken as SRM rules, of which the content is not limited. Preferably, the content of the passport can include descriptions of the passport (e.g. edition, format edition, publisher, publishing company, etc.), descriptions of the application service (e.g. service identifier, edition, name, type, fee, etc.), generation information (e.g. generating date, expired date, installed date, provider, used times, etc.), en-/decryption method and key (e.g. en-/decryption protocol and key), role-based protection of rights (e.g. different stages establishing), framework protection execution (e.g. user license identifiers, whether to perform in an undefined framework), performing or activation method (e.g. manual, automatic, or scheduled execution), execution of software and related service (e.g. software setting or assigning, other required services), and updating method and configuration of application services (e.g. manual, automatic, or scheduled update).

Therefore, via the present invention, the user end and the service end perform SRM via the OSGi framework. As a result, the present invention can not only contain functions of the prior art DRM, but also includes other advantages. For example, via the OSGi framework, digital resources to be managed are not limit in protection of digital contents, and other application services (e.g. home care, network security), software, and digital contents can also be protected and managed, so as to enhance diversity of digital resource contents. Besides, all digital resources can be encrypted and packaged into a bundle, to form an identical format of a digital resource package, and maintain compatibility. In such a situation, each digital resource can be installed, updated, performed, stopped, or deleted via the remote application service of the OSGi framework.

On the other hand, since each digital resource corresponding to each user end has a unique passport, the present invention can easily customize resource management. Meanwhile, the content or format of the passport can be modified or expended, so that the related software to be modified can be remote installed, updated, performed, stopped, and deleted, automatically and dynamically, via the OSGi framework, and is not limited in digital media to provide diverse application service resources. In addition, the passport of the digital resource can designate software to be used, and can be dynamically installed, updated, performed, stopped, and deleted via the OSGi framework to keep integrity of the application service resources. Furthermore, the passport can provide role-based right protection to achieve classification according to different access passwords.

In addition, setting the contents of the passport corresponding to digital resource, and cooperated with operation of monitoring, the present invention can achieve manual, automatic, or scheduled operations, so as to enhance flexibility of execution and utilization of the application service. Moreover, the present invention can automatically delete illegal or invalid digital resources for enhancing security and saving system resource. Furthermore, the OSGi framework is a management and integration platform of the digital application service having network function and open framework, which is developed by Java Technology with a feature of cross platform, so that the present invention also has the same feature.

As to the method of application service management, please refer to the following embodiments.

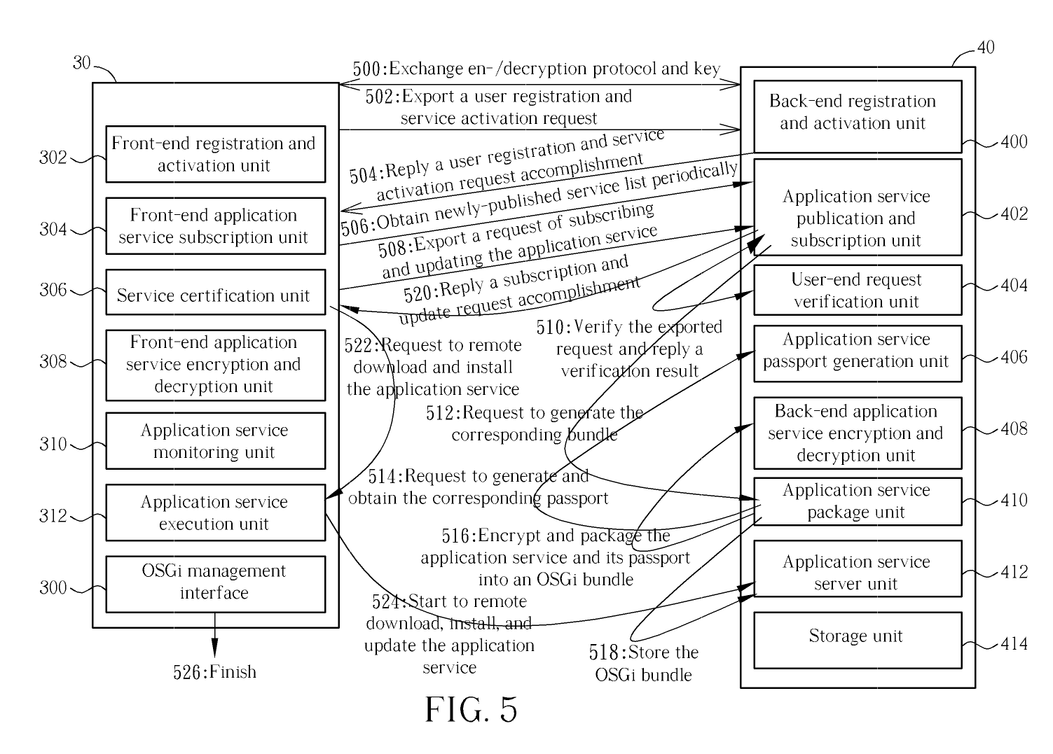

First, please refer to FIG. 5. FIG. 5 is a schematic diagram of a process of subscription, installation, and update of the application service in the DRM system 20 shown in FIG. 2 according to an embodiment of the present invention. In FIG. 5, the process comprises the following steps:

Step 500: The front-end registration and activation unit 302 exchanges en-/decryption protocol and key with the back-end registration and activation unit 400.

Step 502: The front-end registration and activation unit 302 exports a user registration and service activation request to the back-end registration and activation unit 400.

Step 504: The back-end registration and activation unit 400 replies a user registration and service activation request accomplishment to the front-end registration and activation unit 302.

Step 506: The front-end application service subscription unit 304 periodically obtains new service lists published by the application service publication and subscription unit 402.

Step 508: The front-end application service subscription unit 304 exports a request of subscribing and updating the application service to the application service publication and subscription unit 402.

Step 510: The user-end request verification unit 404 verifies the request exported by the front-end application service subscription unit 304, and replies a verification result to the application service publication and subscription unit 402.

Step 512: The application service publication and subscription unit 402 requests the application service package unit 410 to generate the corresponding bundle.

Step 514: The application service package unit 410 requests the application service passport generation unit 406 to generate and obtain the corresponding passport.

Step 516: The back-end application service en-/decryption unit 408 encrypts and packages the application service and its passport into an OSGi bundle.

Step 518: The application service server unit 412 stores the OSGi bundle.

Step 520: The application service publication and subscription unit 402 replies a subscription and update request accomplishment to the front-end application service subscription unit 304.

Step 522: The front-end application service subscription unit 304 requests the OSGi management interface 300 to remote download and install the application service.

Step 524: The OSGi management interface 300 starts to remote download, install, and update the application service.

Step 526: Finish.

Therefore, when subscribing, installing, and updating the application service, the user end 30 exchanges en-/decryption protocol and key with the back-end registration and activation unit 400 of the service end 40 via the front-end registration and activation unit 302, and requests user registration and service activation. Then, the user end 30 periodically obtains new service lists published by the application service publication and subscription unit 402 via the front-end application service subscription unit 304. When the front-end application service subscription unit 304 exports the request of subscribing and updating the application service to the application service publication and subscription unit 402, the user-end request verification unit 404 verifies the request exported by the front-end application service subscription unit 304, and replies verification result to the application service publication and subscription unit 402. The application service publication and subscription unit 402 is capable of requesting the application service package unit 410 to generate the corresponding bundle. When the application service bundle is generated, the application service package unit 410 requests the application service passport generation unit 406 to generate and obtain the corresponding passport, and the back-end application service en-/decryption unit 408 encrypts and packages the application service and its passport into an OSGi bundle. The application service server unit 412 stores the OSGi bundle. Next, the application service publication and subscription unit 402 replies a subscription and update request accomplishment to the front-end application service subscription unit 304. The front-end application service subscription unit 304 can request the OSGi management interface 300 to remote download and install the application service. Finally, the OSGi management interface 300 starts to remote download, install, and update the application service, to complete the process.

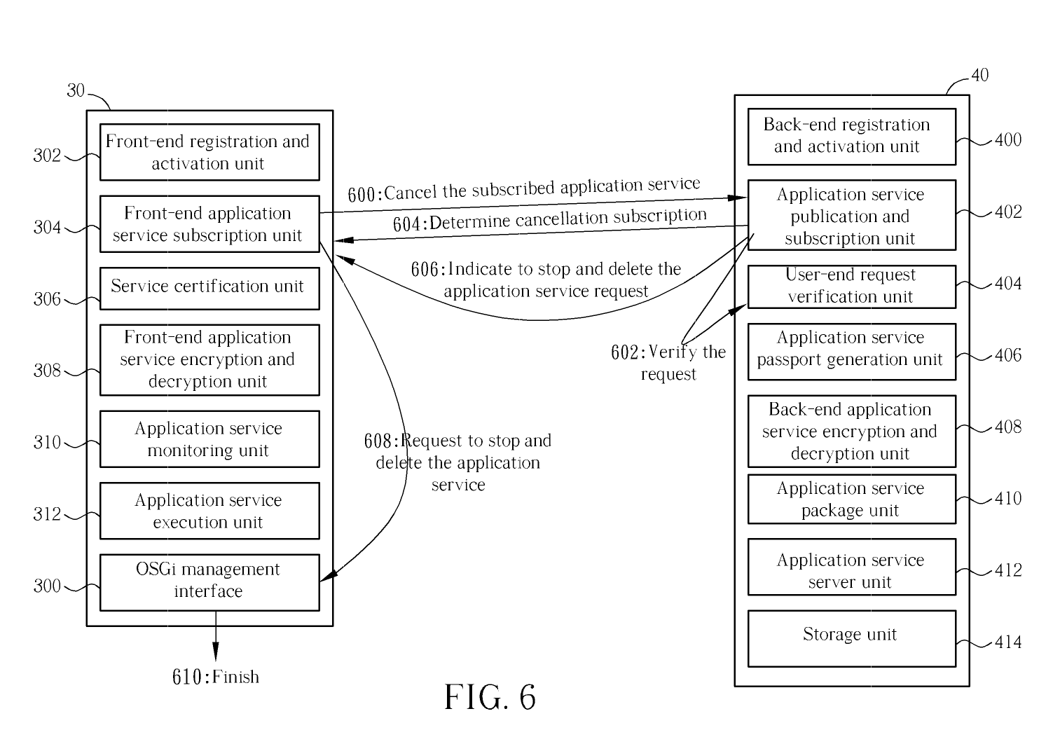

Please refer to FIG. 6. FIG. 6 is a schematic diagram of a cancellation process of the application service in the DRM system 20 shown in FIG. 2 according to an embodiment of the present invention. In FIG. 6, the cancellation process of the application service comprises the following steps:

Step 600: The front-end application service subscription unit 304 indicates the application service publication and subscription unit 402 to cancel the subscribed application service.

Step 602: The user-end request verification unit 404 verifies the request of the front-end application service subscription unit 304.

Step 604: The application service publication and subscription unit 402 determines cancellation subscription of the front-end application service subscription unit 304.

Step 606: The application service publication and subscription unit 402 indicates the front-end application service subscription unit 304 to stop and delete the application service request.

Step 608: The front-end application service subscription unit 304 requests the OSGi management interface 300 to stop and delete the application service.

Step 610: Finish

Therefore, when the user end 30 is in the cancellation process, the front-end application service subscription unit 304 is able to indicate the application service publication and subscription unit 402 to cancel the subscribed application service. The user-end request verification unit 404 verifies the request of the front-end application service subscription unit 304, determines cancellation subscription of the front-end application service subscription unit 304 after verifying, and indicates the front-end application service subscription unit 304 to stop and delete the application service request. Finally, the front-end application service subscription unit 304 requests the OSGi management interface 300 to stop and delete the application service to complete the cancellation process.

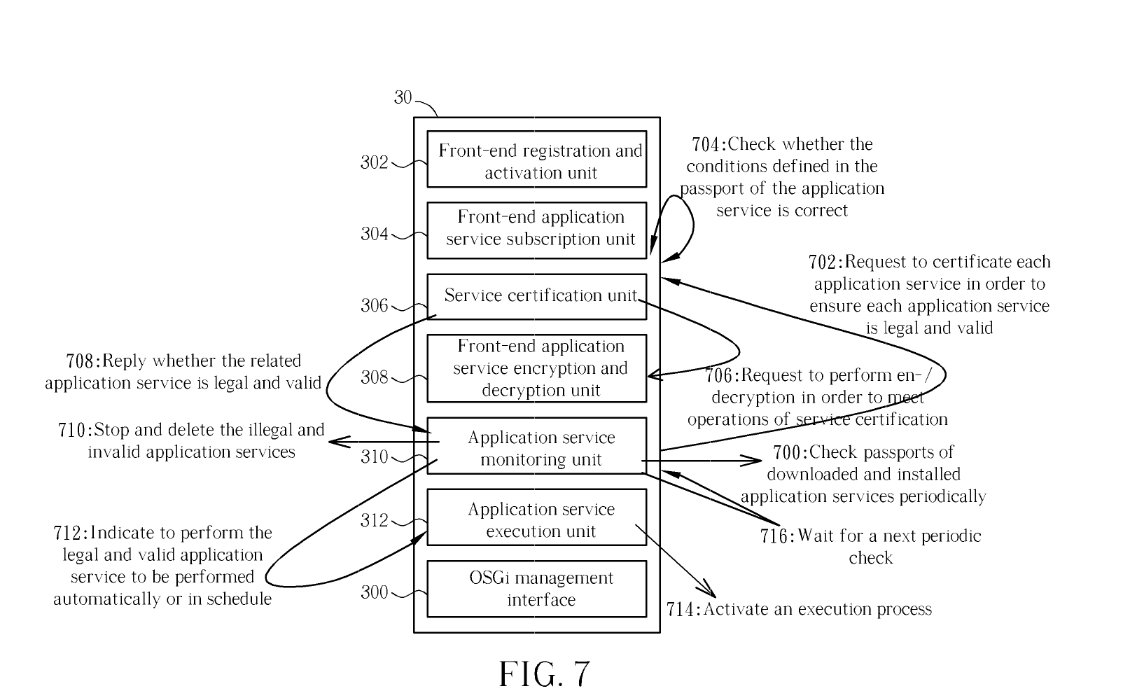

Please refer to FIG. 7. FIG. 7 is a schematic diagram of a periodic certification process of the application service in the DRM system 20 shown in FIG. 2 according to an embodiment of the present invention. In FIG. 7, the periodic certification process comprises the following steps:

Step 700: The application service monitoring unit 310 periodically checks passports corresponding to application services downloaded and installed.

Step 702: The application service monitoring unit 310 requests the service certification unit 306 to certificate each application service in order to ensure each application service is legal and valid.

Step 704: The service certification unit 306 checks whether conditions defined in the passport of the application service is correct.

Step 706: The service certification unit 306 requests the front-end application service en-/decryption unit 308 to perform en-/decryption in order to meet operations of service certification.

Step 708: The service certification unit 306 replies the application service monitoring unit 310 whether the related application service is legal and valid.

Step 710: The application service monitoring unit 310 stops and deletes illegal and invalid application services.

Step 712: The application service monitoring unit 310 indicates the application service execution unit 312 to perform the legal and valid application service to be performed automatically or in schedule.

Step 714: The application service execution unit 312 activates an execution process of the application service.

Step 716: The application service monitoring unit 310 waits for a next periodic check.

Therefore, in the periodic certification process of the application service, the application service monitoring unit 310 can periodically check the passport of the application services downloaded and installed. The service certification unit 306 verifies each application service in order to ensure each application service is legal and valid. The service certification unit 306 then checks whether the conditions defined in the passport of the application service is correct, and requests the front-end application service en-/decryption unit 308 to perform en-/decryption in order to meet operations of service certification. Next, the service certification unit 306 replies the application service monitoring unit 310 whether the related application service is legal and valid. For an invalid or expired application service, the application service monitoring unit 310 can stop and delete the application service, while for a legal and valid application service, the application service monitoring unit 310 can indicate the application service execution unit 312 to perform the legal and valid application service to be performed automatically or in schedule, so as to activate the execution process via the application service execution unit 312. Finally, the application service monitoring unit 310 waits for the next periodic check.

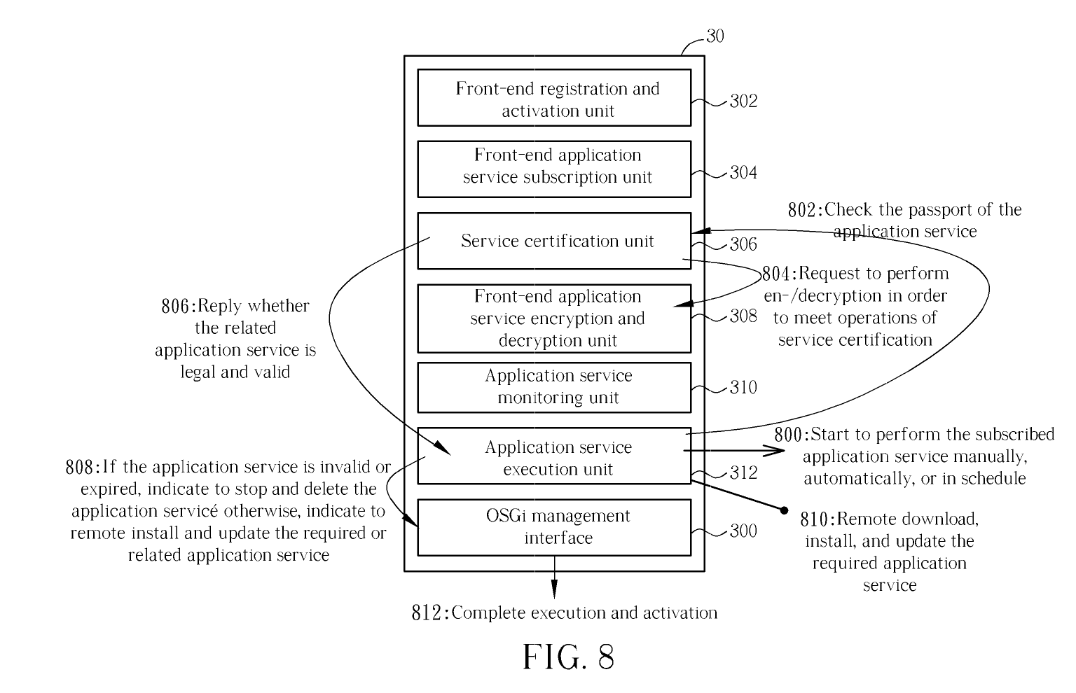

Please refer to FIG. 8. FIG. 8 is a schematic diagram of an execution and activation process of the application service in the DRM system 20 shown in FIG. 2 according to an embodiment of the present invention. In FIG. 8, the execution and activation process comprises the following steps:

Step 800: The application service execution unit 312 starts to perform the subscribed application service manually, automatically, or in schedule.

Step 802: The service certification unit 306 checks the passport of the application service

Step 804: The service certification unit 306 requests the front-end application service en-/decryption unit 308 to perform en-/decryption in order to meet operations of service certification.

Step 806: The service certification unit 306 replies the application service execution unit 312 whether the related application service is legal and valid.

Step 808: If the application service is invalid or expired, the application service execution unit 312 indicates the OSGi management interface 300 to stop and delete the application service. On the contrary, if the application service is legal and valid, the application service execution unit 312 indicates the OSGi management interface 300 to remote install and update the related or required application service.

Step 810: When the application service is no illegal or invalid, the OSGi management interface 300 remote downloads, installs, and updates the required application service from the application service server unit 412.

Step 812: The application service execution unit 312 completes execution and activation.

Therefore, in the execution and activation process, when the application service execution unit 312 starts to perform the subscribed application service manually, automatically, or in schedule, the service certification unit 306 checks the passport of the application service and requests the front-end application service en-/decryption unit 308 to perform en-/decryption, in order to meet operations of service certification. Next, the service certification unit 306 replies the application service execution unit 312 whether the related application service is legal and valid. If the application service is invalid or expired, the application service execution unit 312 indicates the OSGi management interface 300 to stop and delete the application service. On the contrary, if the application service is legal and valid, the application service execution unit 312 can indicate the OSGi management interface 300 to remote install and update the related or required application service. Then, the OSGi management interface 300 can remote download, install, and update the required application service from the application service server unit 412, to complete execution and activation.

In summary, the present invention is OSGi-based SRM, can increase diversity of digital resource contents, maintain compatibility, achieve customization of resource management, provide diverse application service resources, keep integrity of the application service resource, provide role-based right protection, enhance flexibility of execution and utilization of the application service, enhance security, save system resource, and realize the feature of cross framework.

Those skilled in the art will readily observe that numerous modifications and alterations of the device and method may be made while retaining the teachings of the invention.

What is claimed is:

1. A method of digital resource management comprising:
establishing an Open Service Gateway initiative, abbreviated OSGi hereinafter, framework between a user end and a service end;
providing an application service via the OSGi framework for the user end by the service end according to a request of the user end; and
exchanging information corresponding to the application service between the user end and the service end via the OSGi framework for managing the application service.

2. The method of claim 1, wherein providing the application service via the OSGi framework for the user end by the service end according to the request of the user end comprises:
registering and activating authority for using the application service by the user end.

3. The method of claim 2, wherein providing the application service via the OSGi framework for the user end by the service end according to the request of the user end further comprises:
processing the registration of the user end and the activation of the application service by the service end.

4. The method of claim 1, wherein providing the application service via the OSGi framework for the user end by the service end according to the request of the user end comprises:
subscribing the application service by the user end.

5. The method of claim 4, wherein providing the application service via the OSGi framework for the user end by the service end according to the request of the user end further comprises:
publishing the application service and processing the subscription of the application service by the service end.

6. The method of claim 1, wherein providing the application service via the OSGi framework for the user end by the service end according to the request of the user end comprises:
certificating the application service by the user end.

7. The method of claim 1, wherein providing the application service via the OSGi framework for the user end by the service end according to the request of the user end comprises:
verifying the user end by the service end.

8. The method of claim 1, wherein providing the application service via the OSGi framework for the user end by the service end according to the request of the user end comprises:
decrypting the application service by the user end.

9. The method of claim 8, wherein providing the application service via the OSGi framework for the user end by the service end according to the request of the user end further comprises:
encrypting and decrypting the application service and a passport corresponding to the application service by the service end.

10. The method of claim 1, wherein providing the application service via the OSGi framework for the user end by the service end according to the request of the user end comprises:
packaging the application service in an OSGi format by the service end.

11. The method of claim 1, wherein exchanging information corresponding to the application service between the user end and the service end via the OSGi framework comprises:
monitoring information of the application service by the user end.

12. The method of claim 1, wherein exchanging information corresponding to the application service between the user end and the service end via the OSGi framework comprises:
performing the application service by the user end.

13. The method of claim 1, wherein exchanging information corresponding to the application service between the user end and the service end via the OSGi framework comprises:
exporting the application service to the user end via the OSGi framework by the service end.

14. The method of claim 1, wherein exchanging information corresponding to the application service between the user end and the service end via the OSGi framework comprises:
storing data corresponding to the application service and the user end by the service end.

15. A system of digital resource management comprising: an Open Service Gateway initiative, abbreviated OSGi hereinafter, framework;
a user end comprising;
an OSGi management interface connected to the OSGi framework for receiving an application service and related control signals via the OSGi framework;
a front-end registration and activation unit established on the OSGi management interface for registering and activating authority for using the application service;
a front-end application service subscription unit established on the OSGi management interface for subscribing the application service;
a service certification unit established on the OSGi management interface for certificating the application service;
an front-end application service encryption and decryption unit established on the OSGi management interface for decrypting the application service;
an application service monitoring unit established on the OSGi management interface for monitoring information of the application service; and
an application service execution unit established on the OSGi management interface for performing the application service; and
a service end comprising; and
a back-end registration and activation unit for processing the registration of the user end and the activation of the application service;
an application service publication and subscription unit for publishing the application service and processing the subscription of the application service;
a user-end request verification unit for verifying the use end;
an application service passport generation unit for managing status of the user end corresponding to the application service;
a back-end application service encryption and decryption unit for encrypting and decrypting the application service and a passport corresponding to the application service;
an application service package unit for packaging the application service in an OSGi format;
an application service server unit for exporting the application service to the user end via the OSGi framework; and
a storage unit for storing data corresponding to the application service and the user end.
